(19) United States
(12) Patent Application Publication
(10) Pub. No.: US 2008/0061651 A1
(43) Pub. Date: Mar. 13, 2008

(54) Bobbin for a dynamoelectric machine and method

(76) Inventor: Michael T. York, Pendleton, IN (US)

Correspondence Address: CANTOR COLBURN, LLP, 20 Church Street, 22nd Floor, Hartford, CT, 06103, US

(21) Appl. No.: 11/520,544

(22) Filed: Sep. 13, 2006

(51) Int. Cl. H02K 3/00; H02K 1/22; H02K 1/00

(52) U.S. Cl. 310/194; 310/263

(57) ABSTRACT

Disclosed herein is an apparatus that relates to a bobbin of a dynamoelectric machine. The bobbin comprising, a central hub with radial surfaces on axial ends thereof receivable of end caps attachable to the radial surfaces. The central hub is receivable of a wire winding, and at least one radial protrusion extending radially outwardly from one of the radial surfaces is receivable of a wrapped end of the wire winding.

### BACKGROUND OF THE INVENTION

Currently, the majority of vehicles driven today use front-end accessory drive alternators that contain Lundell style rotors, also known as “claw pole” rotors. The rotor provides the alternator's magnetic field and rotates within the dynamoelectric machine. The rotor includes a field coil or coil assembly made up of a number of insulated copper wires wrapped around an electrically insulated bobbin. The bobbin surrounds a steel hub, and also insulates the field coil from the steel pole pieces which sandwich the field coil to form north and south poles. The magnetic field is generated when the field coil is energized and a current flows through the wires.

In such claw pole rotors, it is preferable to incorporate the steel core or hub into the pole pieces. Stated another way, each pole piece includes one half of the steel center hub, thereby forming a single face-to-face contact region. This design is preferred because by reducing the number of contact regions or surfaces, the magnetic field strength of the rotor increases, which is proportional to the amount of power the alternator can provide to the vehicle system. In these designs, the insulating bobbin needs to be sturdy in order to support winding of the field coil directly onto the bobbin, which is not supported by the hub. The bobbin of a typical alternator is therefore made relatively thick.

The end caps of a traditional bobbin are made thick as well, typically in the range of 0.6 to 1.5 mm, to allow the integration of wire tie-offs in the end caps. Tying off one or both ends of the wire to the end caps maintains tension in the wound wire. The thick end caps are required to prevent the end caps from yielding under the tension in the wire. Such tension is important to minimize air gaps between adjacent layers of wound wire to thereby maximize the packing density of copper in the available volume. Another reason to keep the field coil winding tight is to prevent movement of one layer of the wire relative to other layers of the wire. Such movement, if allowed to occur, could result in failure of the insulation, due to rubbing, which could result in electrical shorting and malfunction of the machine. Additionally, having the tie-offs on the bobbin allow the wound bobbin to be removed from the winding machine without the winding unraveling. Commonality of bobbins with tie-offs integrated into the end caps has driven the design of conventional automated winding machines such that many automatically wrap one or both ends of the wire around the tie-offs in the end caps.

Unfortunately, thick bobbin end caps reduce the dissipation of heat in the rotor and occupy space that could be better used for additional field coil or steel. Recent advancements in rotor design have reduced the thickness of the bobbin end caps by using thin laminated layers of material that are attached to the ends of a cylindrical portion of the bobbin by adhesives, welding or heat staking tabs that protrude through slots in the end caps for example. Such thin and flexible end caps are not rigid enough to maintain wire tension by incorporation of tie-offs integrated therein and thus such bobbins are not compatible with conventional winding machines.

Accordingly, there exists a need for bobbins with thin end caps that are compatible with conventional winding machines.

### BRIEF DESCRIPTION OF THE INVENTION

Disclosed herein is an apparatus that relates to a bobbin of a dynamoelectric machine. The bobbin comprising, a central hub with radial surfaces on axial ends thereof receivable of end caps attachable to the radial surfaces. The central hub is receivable of a wire winding, and at least one radial protrusion extending radially outwardly from one of the radial surfaces is receivable of a wrapped end of the wire winding.

Further disclosed herein is a method that relates to maintaining tension in a wound wire. The method comprising, forming a bobbin without end caps, and attaching end caps to axial ends of the bobbin. Winding wire circumferentially around the bobbin between the end caps a plurality of complete rotations to form a winding, and wrapping an end of the wound wire around a radial protrusion of the bobbin to thereby maintain tension in the winding.

### BRIEF DESCRIPTION OF THE DRAWINGS

The following descriptions should not be considered limiting in any way. With reference to the accompanying drawings, like elements are numbered alike:

FIG. 1 depicts a perspective view of a field coil disclosed herein; and

FIG. 2 depicts a perspective view of a bobbin disclosed herein.

### DETAILED DESCRIPTION OF THE INVENTION

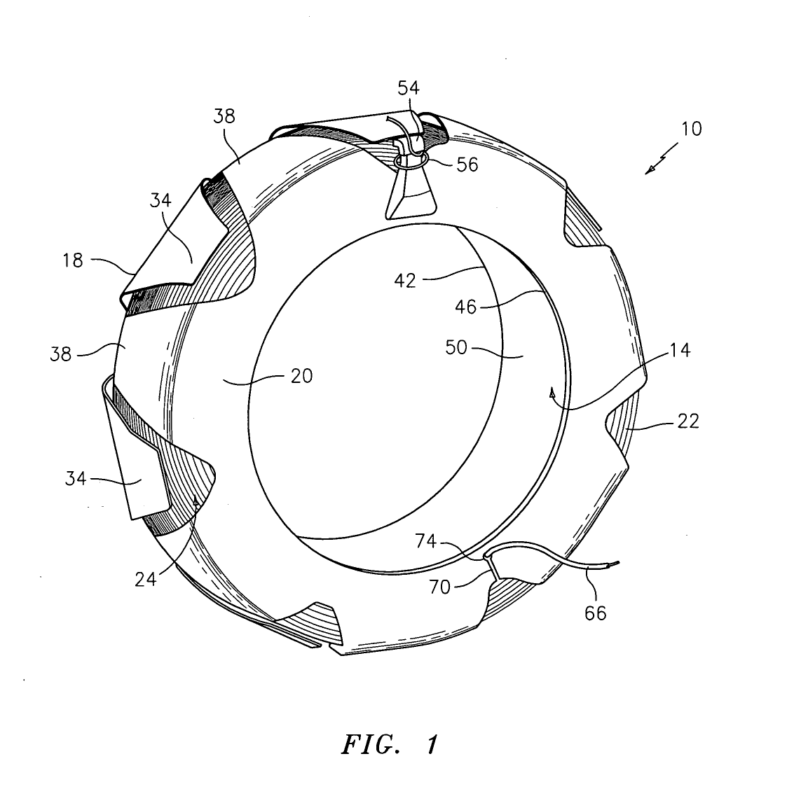

Referring to FIG. 1, a field coil also referred to herein as a coil assembly according to an embodiment of the present invention is generally depicted at 10. The coil assembly 10 comprises a bobbin 14 substantially shaped as a hollow cylinder to which a first end cap 18 and a second end cap 20 are attached to opposing axial ends. Wire 22 is wound around the bobbin 14 between the end caps 18, 20 to form a winding 24. An optional metal sleeve, not shown, may line the inner circumferential surface of the bobbin 14 for additional structural support.

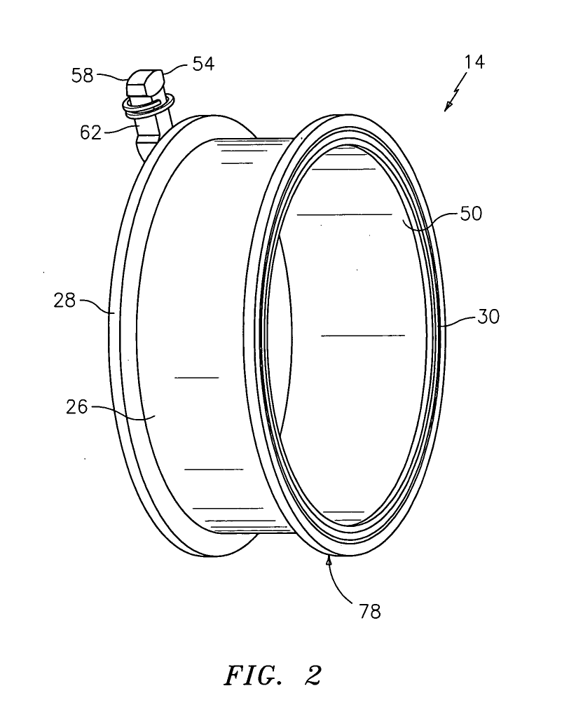

Referring to FIGS. 1 and 2, the bobbin 14 has a central hub 26 that includes a first flange 28 at a first end with a first radial surface 29 and a second flange 30 at a second end with a second radial surface 31, opposite the first end, that extend radially beyond a central cylindrical portion. The first end cap 18 is attached to the first radial surface 29 by adhesive bonding, ultrasonic welding, spin welding or the like. By similar methods the second end cap 20 is attached to the second radial surface 31. Each end cap 18, 20 includes a plurality of flaps 34, 38 that project radially outwardly and are equidistantly spaced about the end caps 18, 20. The flaps 34, 38 are numbered, sized and structured to correspond with fingers of pole pieces, not shown, of a rotor to which the coil assembly 10 is installed. Each of the end caps 18, 20 include a cutout center portion 42, 46 which is sized and shaped to correspond with an inner diameter 50 of the bobbin 14.

The end caps 18, 20 are made from different materials than is used to make the bobbin 14, such as a laminate sheet structure consisting of a combination of Mylar™ and Nomex™ materials, for example. However, a number of other laminates are also acceptable, such as paper laminates or single layer sheets of Mylar or other materials, for example. In addition, stamped or molded polymer end caps may also be used. The laminate structure is preferred because of its ability to resist tearing and puncture. That is, laminates can be designed to exhibit higher tear strength than its plastic polymer counterparts. This allows the field coil 10 to be “crushed” between pole pieces with greater force, increasing the heat transfer by virtue of increased contact area and contact force. Additionally, more wire 22 can be wound into the field coil 10, since the field coil 10 decreases in size when it is sandwiched or crushed between pole pieces.

The thin, in the range of 0.1 to 0.5 mm, flexible nature of the end caps 18, 20, however, prevents using the end caps 18, 20 as anchor points to which the wire 22 may be fastened to maintain tension in the winding 24. In an embodiment of the present invention, therefore, the bobbin 14 includes a tie-off 54 that extends both axially and radially from the first flange 28. By extending axially the tie-off 54 does not encroach into the volume that the winding 24 occupies and it allows the tie-off 54 to fit through an opening, not shown, in the second end cap 20. By extending radially, the tie-off 54 forms a protrusion around which a wire end 56 can be wound upon completion of the winding process. The rigidity of the bobbin 14 provides adequate stability for the tie-off 54 to maintain tension in the winding 24 after completion of the winding operation. The tie-off 54 has a head 58, which has a larger cross sectional area than a central portion 62 to prevent the wire 22, wound around the tie-off 54, from inadvertently slipping off of the tie-off 54.

The tie-off 54 can be injection molded as an integral part of the bobbin 14 itself or may be a separate component that is attached by means of welding, adhesive bonding, etc. Integrally molding the tie-off 54 as part of the bobbin 14 eliminates additional processing steps for forming and attaching a separate tie-off 54 component and may therefore be advantageous for economic reasons.

The presence of the tie-off 54 permits the automatic conventional winding machine to wrap an end of the wire 22 around the tie-off 54 for a few rotations prior to the wire 22 being cut. The elasticity and memory of the wire 22 prevents the end from unwrapping from the tie-off 54 and thereby maintains the tension of the winding 24 around the hub 26 of the bobbin 14.

A first end 66 of the wire 22 is automatically positioned, by the winding machine, in an axial orientation relative to the bobbin 14, through a slit 70 and into a hole 74 formed in the second end cap 20, prior to the beginning of the winding process. The hole 74 is located radially in line with an outer diameter 78 of the second flange 30 to properly position the wire 22 for initiation of the winding process. The winding machine holds the first end 66 fixed relative to the first end cap 20 and hub 26 throughout the winding process. Upon completion of the winding process the first end 66 is sandwiched between the hub 26 and the outer layers of the winding 24 thereby frictionally locking the first end 66 to the bobbin 14.

Alternately, the first end 66 could be wrapped around a second tie-off, not shown, that could be attached to either of the end caps 18, 20, to maintain tension in the winding 24 from the beginning of the winding process while not deviating from the spirit and scope of the present invention.

After the wire 22 has been wound onto the bobbin 14 and anchored around the tie-off 54, the flaps 34, 38 of the end caps 18, 20 can be folded down over the field coil 10, and then held in place with tape, not shown. By connecting the end caps 18, 20 together via the flaps 34, 38, by way of the tape, the winding 24 is prevented from overcoming the thin end cap sidewalls causing bulging or sagging of the coil 10. Alternatively, the tape could be replaced with an adhesive, mechanically interlocking flaps 34, 38 or other fastening means to secure the flaps 34, 38 of opposing end caps 18, 20 together. The tape, however, could also be eliminated in applications that can afford to allow the coil to sag before assembly.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A dynamoelectric machine bobbin, comprising:
a central hub with radial surfaces on axial ends thereof receivable of end caps attachable to the radial surfaces, the central hub being receivable of a wire winding; and
at least one radial protrusion extending radially outwardly from one of the radial surfaces receivable of a wrapped end of the wire winding.

2. The bobbin of claim 1, wherein:
the bobbin is for a rotor of an alternator.

3. The bobbin of claim 1, wherein:
the central hub is molded of a plastic resin.

4. The bobbin of claim 1, wherein:
the at least one radial protrusion is integrally formed with the central hub.

5. The bobbin of claim 1, wherein:
the protrusion has adequate rigidity to resist yielding to the tensile force in the wire resulting from the winding.

6. The bobbin of claim 1, wherein:
the end caps lack adequate rigidity to resist yielding to the tensile force in the wire resulting from the winding.

7. The bobbin of claim 1, wherein:
the end caps are attached to the central hub by welding.

8. The bobbin of claim 7, wherein:
the welding process is performed ultrasonically.

9. The bobbin of claim 1, wherein:
the radial protrusion extends axially through an opening in one of the end caps.

10. The bobbin of claim 1, wherein:
the end caps are laminations.

11. The bobbin of claim 1, wherein:
the radial protrusion is positioned axially outside of the winding volume.

12. The bobbin of claim 1, wherein:
the radial protrusion is integrally molded with the central hub.

13. The bobbin of claim 1, wherein:
the radial protrusion is welded to the central hub.

14. The bobbin of claim 1, wherein:
the radial protrusion is adhesively bonded to the central hub.

15. A method of maintaining tension in a winding, comprising:
forming a bobbin without end caps;
attaching end caps to axial ends of the bobbin;
winding wire circumferentially around the bobbin between the end caps a plurality of complete rotations to form a winding; and
wrapping an end of the wound wire around a radial protrusion of the bobbin to thereby maintain tension in the winding.

16. The method of claim 15, further comprising:
securing a second end of the wire opposite the end wrapped around the radial protrusion to the bobbin by winding at least one layer of the wire radially over the wire near the second end.

17. The method of claim 15, further comprising:
securing a second end of the wire opposite the end wrapped around the radial protrusion by wrapping the second end around a second radial protrusion of the bobbin.

18. The method of claim 15, further comprising:
automatically winding the wire on the bobbin with a machine.

19. The method of claim 15, further comprising:
automatically wrapping the wire around the radial protrusion with a machine.

20. The method of claim 15, wherein the attaching of the end caps to axial ends of a bobbin is by welding.
